(19) United States
(12) Patent Application Publication
(10) Pub. No.: US 2004/0000030 A1
(43) Pub. Date: Jan. 1, 2004

(54) Multifunction container hinge

(76) Inventors: Brian R. Pleiman, Wooster, OH (US); Erik L. Skov, Akron, OH (US); William F. Croft, Wooster, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/434,706

(22) Filed: May 9, 2003

Related U.S. Application Data
(60) Provisional application No. 60/379,362, filed on May 9, 2002.

(51) Int. Cl. E05D 7/10

(52) U.S. Cl. 16/267

(57) ABSTRACT

A multipurpose hinge assembly includes a male and a female hinge portion. The male hinge portion includes a fulcrum and at least one cavity, and the female hinge portion includes a receptacle region that engages and rotates about the fulcrum. In one hinge position, a groove located near the female hinge portion, and a ridge located near the male hinge portion engage thereby creating a weatherproof seal.

### RELATED APPLICATION DATA

The present application is based on co-pending provisional Application No. 60/379,362 which was filed on May 9, 2002.

### FIELD OF THE DISCLOSURE

The disclosure relates generally to a hinge, and more particularly, to a multifunction hinge having weather-proofing qualities.

### BACKGROUND OF THE DISCLOSURE

There are devices and especially container type devices that use hinges to facilitate the opening and closing of a door or lid of the device. The manufacturing cost for typical hinges is high and the amount of operable pieces required to manufacture such hinges is numerous, thereby increasing the chances of malfunction or failure of one of the components of the hinge. To construct a common hinge, the manufacturer may be required to obtain or manufacture four or more different parts. The manufacturer may then need to take the time necessary to assemble the various pieces. For example, the hinge may consist of a first hinge piece, a second hinge piece, a hinge rod and means to fasten the hinge pieces to the device. The assembly of the hinge would require the assembler to align the first and second hinge pieces, connect the first and second hinge pieces with the hinge rod, and fasten the hinges to the device using fastening means such as screws.

To improve the hinge, or to add additional features to the hinge, the manufacturer would have to add-on one or more pieces to the device or hinge. Other features may include weatherproofing or sealing the hinge, to avoid exposure of the device to the elements, or incorporating a door or lid regulator for regulating the opening and/or closing distance of the door or lid. In the past, weather-stripping made from rubber or the like has been added to the hinge to provide a better seal between the lid or door and the device. The weather-stripping, however, has a tendency to become unglued or become damaged. Even though the hinge may include weather-stripping, there usually remains a gap on either side of the hinge between the ends of the weather-stripping and the ends of the hinge, which allows for the elements, such as rain and snow for example, to penetrate into the device. Similarly, attempts have been made to regulate the opening and closing of the door or lid by disposing strings, cables or other restraining members between the hinge and the device. The restraining members, however, have a tendency to break, get in the way of the hinge, and/or become dislodged from the lid/door or device.

### SUMMARY OF THE DISCLOSURE

In accordance with one aspect of the disclosure, a multipurpose hinge assembly for rotatably connected a first object and a second object is disclosed. The first object includes a male portion and a mating surface having a ridge, and the male portion includes a fulcrum that is connected to the mating surface. The second object includes a female portion having a receptacle region, and a groove. The receptacle region receives the fulcrum, and the ridge engages the groove when the hinge assembly is in a closed position.

### BRIEF DESCRIPTION OF THE DRAWINGS

The advantages of the present invention will be apparent upon reading the following description in conjunction with the drawings, in which:

FIG. 1 is perspective view of a multifunction container hinge; and

FIG. 2 is a perspective view of a box, a lid and the multifunction container hinge of FIG. 1.

FIG. 3 is a detail perspective view of a cavity of FIG. 1,

FIG. 4 is a cross sectional view of the multifunction container hinge of FIG. 1 in the closed position;

FIG. 5 is a cross sectional view of the multifunction container hinge of FIG. 1 in the open position; and

FIG. 6 is a perspective view of a box, a pair of lids and a pair of multifunction container hinges.

While the invention is susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention and the appended claims.

### DETAILED DESCRIPTION

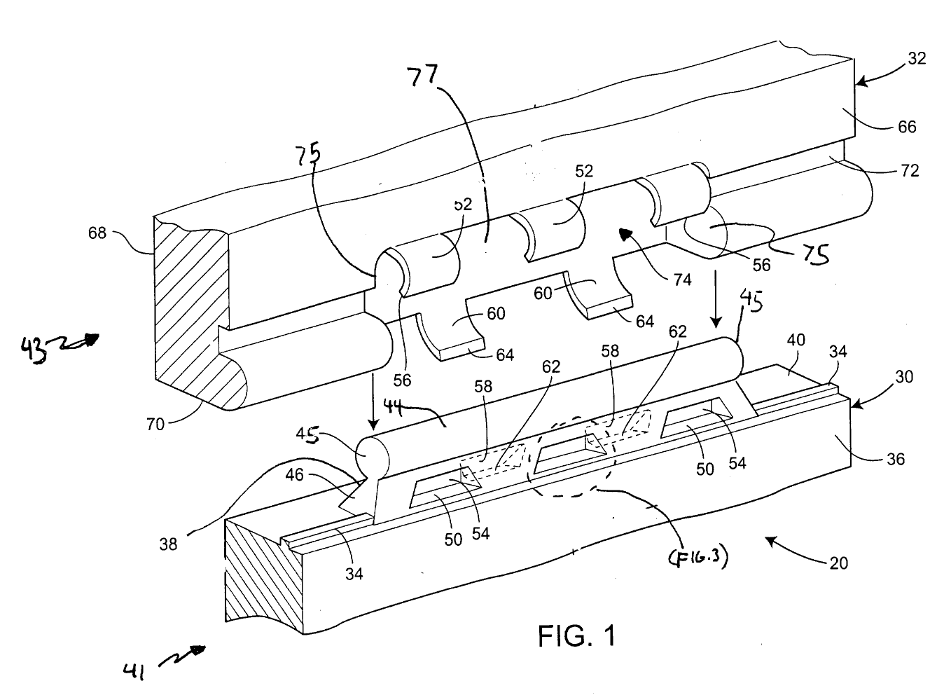

Referring now to the drawings, and with specific reference initially to FIG. 1, a container hinge 20 has a male portion 30, a female portion 32, and may include a sealing ridge 34. The container hinge 20 may be fabricated from relatively light weight, durable, and sturdy plastic materials such as polyethylene, polypropylene, polystyrene, or other suitable plastic materials. Similarly, the container hinge 20 may be injection molded, blow molded, continuously molded, extruded, vacuum formed, or the like. The manufacturing process or processes and materials can be selected based on feasibility, cost, tooling concerns, as well as other factors for a given application.

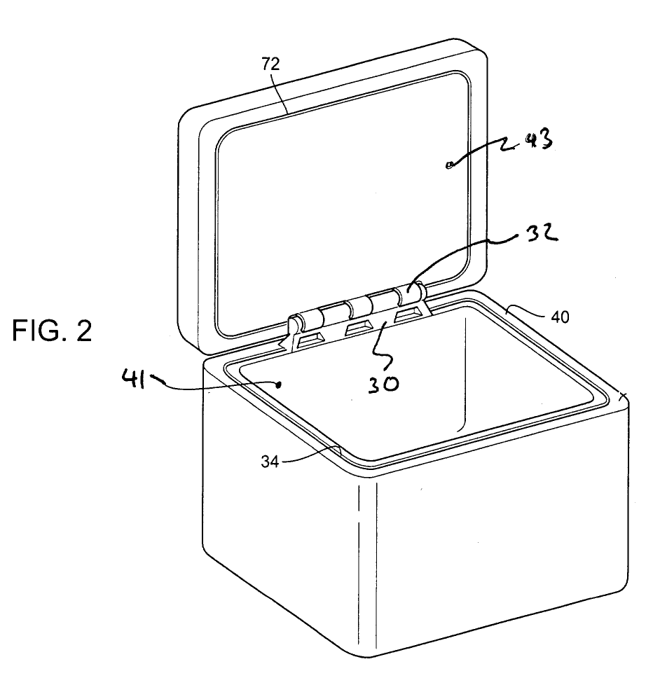

The male portion 30 of the container hinge 20 may be the portion of the container hinge 20 that is part of, or is attached to, a body 41 of a structure (i.e. container, shed, box or the like), and the female portion 32 of the container hinge 20 may be the portion of the container hinge 20 that is part of, or is attached to, an openable structure 43 (i.e. door or lid). As illustrated in FIG. 2, the male portions 30 is an integral part of the container 41, and the female portion 32 is an integral part of the lid 43. In another example, the male portion 30 and the female portion 32, of the container hinge 20 may be reversed and part of or attached to the openable structure 43 and body 41 of a structure, respectively.

The container hinge 20 can further be described as having an interior and an exterior. More specifically, as illustrated in FIG. 2, the interior of the container hinge 20 is located toward and facing the inside of the container 41, and the exterior of the container hinge 20 is located toward and facing the outside of the container 41.

In one exemplary embodiment, the male portion 30 of the container hinge 20 includes an inside surface 36, an outside surface 38, and may include the sealing ridge 34. As illustrated in FIG. 2, the male portion 30 and the sealing ridge 34 are disposed on and project from a mounting surface 40 of the body 41. The sealing ridge 34 may have a square, round, rectangular, triangular, or any other transverse cross sectional profile shape desirable. Further, the sealing ridge 34 may be disposed along the entire length of the mounting surface 40 and/or may be disposed on the mounting surface 40, such that the sealing ridge 34 engages with that portion of the lid or openable structure that rests upon the mating surface 40. More specifically, as seen in FIG. 2, the mating surface 40 extends along the entire top portion of the container 41. The sealing ridge 34, in this example, abuts the male portion 30 on one or both ends of the male portion 30 and may, in combination with the male portion 30, form a contiguous wall along the entirety of the container hinge 20 or the mounting surface 40.

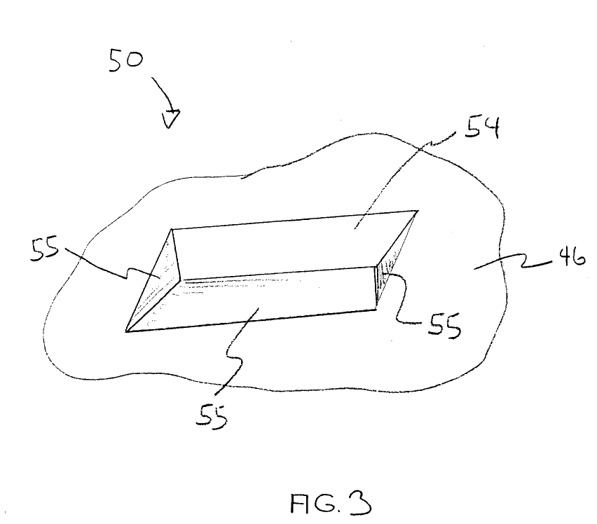

In one exemplary embodiment, as seen in FIGS. 1 and 3, the male portion 30 may include a fulcrum 44 having a generally circular cylindrical surface and a pair of end surfaces 45. The fulcrum is supported on the mounting surface 40 via a base 46. The fulcrum 44 has a center axis that is oriented such that the axis runs parallel to the mounting surface 40 having on either end an end surface 45. The end surfaces 45 may be oriented substantially perpendicular to the center axis of the fulcrum 44, and may be substantially similar in shape as the fulcrum 44. The fulcrum 44 engages a receptacle region 74 which is defined in the female portion 32 when the container hinge 20 is assembled.

The base 46 may be square, round, rectangular, triangular, or any other shape desirable, and in this exemplary embodiment has a substantially tetrahedral configuration. More specifically, the base 46 is located between the mating surface 40 and the fulcrum 44, and may be an integral part of the container 41, but may also be constructed separately. The base 46 includes the inside surface 36, which extends from near an inside edge of the mating surface 40 to the fulcrum 44, and outside surface 38 which extends from near an outside edge of the mating surface 40 to the fulcrum 44. The fulcrum 44 and the base 46 may be a contiguous piece, but may be one or more separate pieces.

The interior surface 36 includes one or more interior cavities 50 that may be any suitable shape including round, oval, elliptical, or polygonal with three or more sides, and may be disposed between the fulcrum 44 and the mounting surface 40. As seen in FIG. 3, the cavities 50, in this example, include a stop surface 54 and a plurality of guide surfaces 55. More specifically, the stop surface 54 extends downwardly and inwardly from the upper part of the cavities 50, two guide surfaces 55 located to the either side of the cavities 50 extend toward each other and inwardly from the sides of the cavities 50 and abut the sides of the stop surface 54, and a third guide surface 55 located near a bottom of the cavities 50 extends inwardly and upwardly from the sides of the cavities 50 and abuts the bottom of the stop surface 54.

One or more exterior cavities 58 are disposed on the outside surface 38 of the base 46 in this example. The exterior cavities 58 may be similar or in shape and size to the interior cavities 50, or may be round, oval, elliptical, or polygonal. The cavities 58 are disposed between the fulcrum 44 and the mounting surface 40, and may be disposed on the outside surface 38 of the base 46 in areas unoccupied by the interior cavities 50. More specifically, as best shown in FIG. 1, the cavities 50 located on the interior surface 36 extend into the base 46 toward the exterior surface 38. Depending on the depth of the interior cavities 50, the cavities 50 may extend through a majority of the base 46. If the interior cavities 50 extend half-way through the base 46 or more, then if the exterior cavities 58 are placed directly behind the interior cavities 50, the cavities 50, 58 will interfere with each other. By staggering or alternating the interior and exterior cavities 50, 58 along the base 46, the cavities 50, 58 may have a greater depth into the base 46 without interfering with each other.

As illustrated in FIG. 2, the female portion 32 of the container hinge 20, in this exemplary embodiment, is located on an underside of the lid 43 and includes the receptacle region 74, the tabs 52, 60, and a groove 72. The groove 72 may be square, round, rectangular, triangular, or any other shape desirable, and is disposed on the underside of the lid 43, and/or can be disposed on an area of the lid corresponding to or confronting the mounting surface 40 of the container when the lid is closed. The groove 72 terminates at the recess portion 74 on one or both ends of the female portion 30, and may in combination with the recess portion 74, form a contiguous groove along the underside of the lid 43.

In this example, the groove 72 is adapted to receive the sealing ridge 34 when the lid is closed. The groove 72 is complimentary to the sealing ridge 34 to permit the opening and closing of the lid and container hinge 20. The groove 72 and/or ridge 34 can include a clearance or taper to avoid contact during hinged opening and closing.

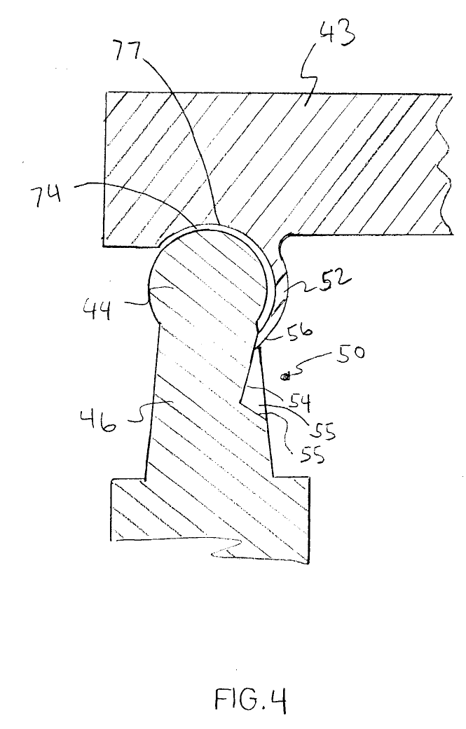

In one exemplary embodiment, as best seen in FIGS. 1 and 4, the interior tabs 52 are located toward the inside of the female portion 32 and extend outwardly and downwardly from near an inside edge of the recess portion 74. The interior tabs 52 have a substantially inwardly curved shape and include sliding surfaces 75 and ends 56. The sliding surfaces 75 of the interior tabs 52 may compliment and extend the inside surface 77 of the recess portion 74. More specifically, the sliding surfaces of the interior tabs 52 may substantially abut the generally circular surface of the fulcrum 44, such that the interior tabs 52 slide about around the fulcrum 44, during rotation of the female portion 32 about the fulcrum 44.

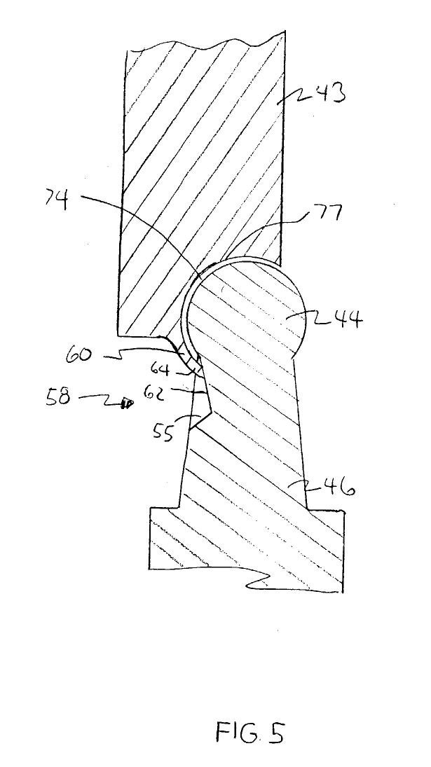

Similarly, located toward the outside of the female portion 32 near the receptacle region 74 and extending outwardly and downwardly therefrom, are the one or more exterior tabs 60, as best seen in FIGS. 1 and 5. The exterior tabs 60 may be substantially similar to the interior tabs 52, having a substantially inwardly curved shape and including sliding surfaces 79 and ends 64. The sliding surfaces 79 of the exterior tabs 60 may compliment and extend the inside surface 77 of the recess portion 74.

The recess portion 74 and more particularly, the inside surface 77 of the recess portion 74, as seen in FIGS. 4 and 5, may create in combination with the interior tabs 52 and/or the exterior tabs 60, a complimentary shape to the fulcrum 44, such that a combination of the inside surface 77, the interior tabs 52 and/or the exterior tabs 60 retains the fulcrum and allows rotation thereabout. More specifically, a combination of the inside surface 77, the interior tabs 52 and/or the exterior tabs 60 may receive the fulcrum 44, such that the fulcrum 44 snaps into the combination recess portion 74, the interior tabs 52 and/or the exterior tabs 60. In another exemplary embodiment, the recess portion 74 includes a plurality of end surfaces 75. More particularly, as best seen in FIG. 1, the recess portion 74 includes side boundaries that define at least part of the recess portion 74. Those side boundaries are created by the end surfaces 75.

In one exemplary embodiment, as seen in FIG. 4, the ends 56 of the interior tabs 52 are adapted to engage with the stop surfaces 54 of the interior cavities 50, when the container hinge 20 is in a closed position. More specifically, the number and location of the interior tabs 52 may correspond and be aligned to the interior cavities 50. Similarly, as seen in FIG. 5, the ends 64 of the exterior tabs 60 are adapted to engage with stop surfaces 62 of the exterior cavities, when the container hinge 20 is in an open position, and more specifically, the number and location of the exterior tabs 60 may correspond and be aligned to the interior cavities 58.

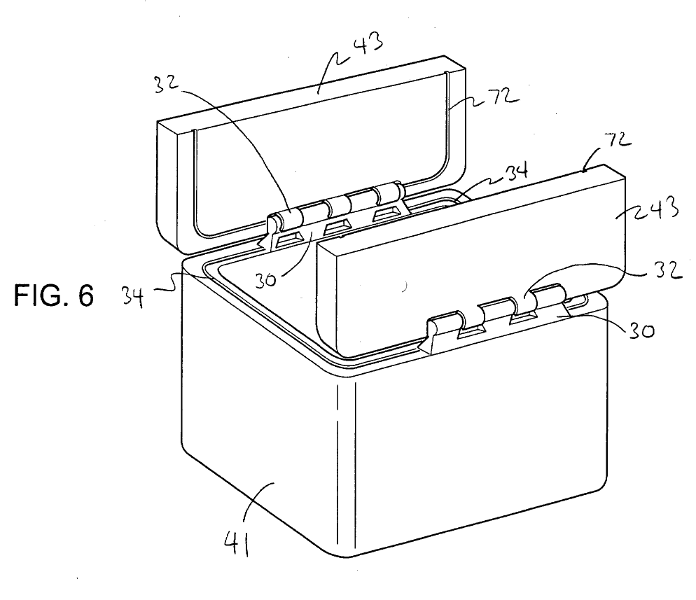

In one example embodiment, as illustrated in FIG. 6, the container hinge 20 may be utilized in combination with additional container hinges 20 and openable structures 43, such as lids. In this embodiment the sealing ridge 34 located on the mating surface 40 may be separated into several sections, and may continue to create in combination with the male portions 30 a contiguous wall. Similarly, the groove 72 may also be separated into several sections, may extend over one or more openable structures 43, and may continue to create in combination with the female portions 32 a contiguous recess. More specifically, as seen in FIG. 6, the sealing ridge 34 extends between the male portions 30, thereby creating in combination with the male portions 30, a contiguous wall. Similarly, the groove 72 extends from the female portions, and more particularly from the receptacle portions 74, toward the edges of the respective lids 43. Once the container is in the closed position (not shown), i.e. the lids 43 are both in the lower position such that the bottom surface of the lids 43 are adjacent the mating surface 40, the groove 72 will connect and create a continues recess in combination with the receptacle portions 74.

In operation, the male portion 30 or the female portion 32 may be attached to the solid structure, the container 41, or to the openable structure, the lid 43, as seen in FIG. 2, and will herein be described as such.

As seen in FIGS. 1, 3 and 4, the male and female portions 30, 32 of the container hinge 20 are engaged by snapping the fulcrum 44 of the male portion 30 into the receptacle region 74 of the female portion 32. Once snapped into place, the fulcrum 44 is engaged with the receptacle region 74 or is engaged with a combination of the receptacle region 74, the interior tabs 52 and the exterior tabs 60, such that the fulcrum 44 rotates within the receptacle region 74, thereby allowing the lid 43 to open and close.

Once the fulcrum 44 and the receptacle regions 74 are engaged, several other components become aligned and engaged as well. For example, as the fulcrum 44 and the receptacle region 74 are engaged thereby permitting rotational movement of the lid 43, the end surfaces 45 of the fulcrum 44 and the receptacle region 74 may engage, thereby restricting the axial movement of the lid 43. More specifically, as the fulcrum 44 and the receptacle region 74 are snapped together, the length of the fulcrum 44 may be slightly shorter than the length of the recess portion 74, thereby enabling the recess portion 74 to restrict the axial movement of the fulcrum 44, and hence the lid 43.

Restricting the axial movement of the lid 43 may also be accomplished by aligning and engaging the interior tabs 52 with the interior cavities 50, and/or by aligning and engaging the exterior tabs 60 with the exterior cavities 58. More specifically, the width of the interior tabs 52 is slightly smaller than the width of the interior cavities 50. When the tabs 52 and cavities 50 are engaged, the tabs 52 will be restricted from moving in an axial direction. Similarly, the width of the exterior tabs 60 is slightly smaller than the width of the exterior cavities 58. When the tabs 60 and cavities 58 are engaged, the tabs 60 will be restricted from moving in an axial direction.

In one exemplary embodiment, as illustrated in FIGS. 1, 3, 4 and 5, the tabs 52, 60 may be guided into the cavities 50, 58 via the guide surfaces 55 located in the cavities 50, 58. More specifically, as the tabs 52 and 60 rotate about the fulcrum during opening of the container hinge 20, the exterior tabs 60 will rotate towards the exterior cavities 58. Before the ends 64 of the exterior tabs 60 abut the stop surfaces 54 of the exterior cavities 58, the ends 64 may be guided toward stop surface 54 by the guide surfaces 55 which are angled toward the stop surfaces 54. Similarly, as the tabs 52 and 60 rotate about the fulcrum during closing of the container hinge 20, the interior tabs 52 will rotate towards the interior cavities 50. Before the ends 56 of the interior tabs 52 abut the stop surfaces 54 of the interior cavities 50, the ends 56 may be guided toward stop surface 54 by the guide surfaces 55 that are angled toward the stop surfaces 54.

In one exemplary embodiment, as best illustrated in FIGS. 4-5, the container hinge 20 includes a set of stops. A first stop can be optionally provided to prevent the lid 43 from opening farther than desired, and a second stop can be optionally provided to prevent the lid 43 from closing farther than desired. More specifically, the tabs 52 and 60 can be manufactured in predetermined lengths, and/or the one or more cavities 50 and 58 can be manufactured in different depths to effectuate and regulate the first and second stops. For example, as shown in FIG. 5, as the lid 43 is opened the ends 64 of the exterior tabs 60 will move toward the stop surfaces 62 of the exterior cavities 58. If the overall distance, between the ends 64 and the stop surfaces 62 is reduced, by either increasing the length of the exterior tabs 60 and/or by decreasing the depth of the stop surfaces 62, or if the distance between the ends 64 and the stop surfaces 62 is increased by either decreasing the length of the exterior tabs 60 and/or by increasing the depth of the bottoms 62, the opening distance of the lid 43 may be regulated

Similarly, as best seen in FIG. 4, as the lid 43 is closed, the ends 56 of the interior tabs 52 will move toward the stop surfaces 54 of the interior cavities 50. If the distance, between the ends 56 and the stop surfaces 54 is reduced, by either increasing the length of the interior tabs 52 and/or by decreasing the depth of the stop surfaces 54, or the overall distance between the ends 56 and the stop surfaces 54 is increased by either decreasing the length of the interior tabs 52 and/or by increasing the depth of the stop surfaces 54, the closing distance of the lid 43 may be regulated. However, in the disclosed example, the lid 43 will abut the mounting surface 40 of the container 41 in the closed position. Thus, this feature may not be needed.

In one exemplary embodiment, the container 41 includes the mounting surface 40. The sealing ridge 34 is located on the mounting surface 40, and abuts the male portion 30 on either side of the base 46. The combination of the sealing ridge 34 and the male portion 30 creates a contiguous wall on the mounting surface 40. The groove 72 is located on the underside of the lid 43, and abuts the recess portion 74 on both ends of the recess portion. The combination of the groove 72 and the receptacle region 74 creates a contiguous void on the underside of the lid 43. When the hinge 20 is in the closed position the contiguous wall engages with the contiguous void to create a seal such that elements such as water, dirt, particles, leaves or the like, are prevented from entering the interior of the container 41.

While the present hinge has been described with reference to specific examples which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A multipurpose hinge assembly comprising:
a first object; and
a second object, wherein the first and second objects are rotatable relative to one another,
the first object including at least one male hinge portion and a mating surface having a ridge, wherein the at least one male hinge portion includes a fulcrum that is connected to the mating surface,
the second object including a first female hinge portion and a first groove, wherein the first female hinge portion includes a receptacle region,
wherein the receptacle region receives the fulcrum of the at least one male hinge portion, and the ridge engages the first groove when the hinge assembly is in a closed position.

2. The multipurpose hinge assembly of claim 1, wherein a combination of the at least one male hinge portion and the ridge create a contiguous wall.

3. The multipurpose hinge assembly of claim 1, wherein the fulcrum snaps into the receptacle region.

4. The multipurpose hinge assembly of claim 1, wherein the hinge assembly is constructed from one of a polyethylene, polypropylene, and polystyrene material.

5. The multipurpose hinge assembly of claim 1, wherein the first and second objects are each respectively integrally formed.

6. The multipurpose hinge assembly of claim 1, wherein the hinge assembly is manufactured using one of an injection molded, blow molded, continuously molded, extruded, and vacuum formed process.

7. The multipurpose hinge assembly of claim 1, further including a third object including a second female portion and a second groove and being rotatable relative to the first object.

8. The multipurpose hinge assembly of claim 7, wherein a combination of the first female portion, the second female portion, the first groove and the second groove create a contiguous recess.

9. The multipurpose hinge assembly of claim 1, further including a second male hinge portion, wherein a combination of the first male hinge portion, the second male hinge portion, and the ridge create a contiguous wall.

10. A multipurpose hinge assembly comprising:
a first object; and
a second object, wherein the first and second objects are rotatable relative to one another,
the first object including a male hinge portion having a fulcrum, and at least one cavity disposed near the male hinge portion,
the second object including a female hinge portion, wherein the female hinge portion includes a receptacle region and at least one inwardly curved tab located near an edge of the receptacle region,
wherein the receptacle region receives the fulcrum, and the at least one tab engages the at least one cavity when the hinge assembly is in one of an open and closed position.

11. The multipurpose hinge of claim 10, wherein the at least one cavity and the at least one inwardly curved tab are located toward an inside of the hinge assembly and engage with one another when the hinge is in the closed position.

12. The multipurpose hinge of claim 10, wherein the at least one cavity and the at least one inwardly curved tab are located toward an outside of the hinge assembly and engage with one another when the hinge is in the open position.

13. The multipurpose hinge assembly of claim 10, wherein the at least one tab in part creates a portion of the receptacle region.

14. The multipurpose hinge assembly of claim 10, wherein the fulcrum snaps into the receptacle region.

15. The multipurpose hinge of claim 10, wherein the hinge assembly is constructed from one of a polyethylene, polypropylene, and polystyrene material.

16. The multipurpose hinge of claim 10, wherein the first and second objects are each respectively integrally formed.

17. The multipurpose hinge assembly of claim 10, wherein the hinge assembly is manufactured using one of an injection molded, blow molded, continuously molded, extruded, and vacuum formed process.

18. A multipurpose hinge assembly comprising:
at least one first hinge portion having a fulcrum, and at least one cavity;
at least one second hinge portion having a receptacle region and at least one inwardly curved tab located near an edge of the receptacle region;
a mating surface, wherein the at least one first hinge portion is connected to the mating surface;
a ridge located on the mating surface, wherein the ridge abuts the at least one first portion; and
a first groove located adjacent the receptacle region of the at least one second portion,
wherein the receptacle region is adapted to pivotally receive the fulcrum, the at least one tab is adapted to engage the at least one cavity when the hinge assembly is in one of a closed and an open position, and the first groove receives the ridge when the hinge is in the closed position.

19. The multipurpose hinge assembly of claim 18, wherein a combination of the at least one male hinge portion and the ridge create a contiguous wall.

20. The multipurpose hinge assembly of claim 18, wherein the fulcrum snaps into the receptacle region.

21. The multipurpose hinge assembly of claim 18, wherein the first and second portions are each respectively integrally formed.

22. The multipurpose hinge assembly of claim 18, further including a pair of second hinge portions each having a receptacle region and at least one inwardly curved tab located near an edge of the receptacle region of the respective second portion.

23. The multipurpose hinge assembly of claim 22, further including a groove located adjacent the receptacle region of each of the second portions, wherein a combination of the pair of second portions and the grooves create a contiguous recess.

24. The multipurpose hinge assembly of claim 18, wherein a combination of more than one first hinge portions and the ridge create a contiguous wall.

25. The multipurpose hinge of claim 18, wherein the at least one cavity and the at least one inwardly curved tab are located toward an inside of the hinge assembly and engage with one another when the hinge is in the closed position.

26. The multipurpose hinge of claim 18, wherein the at least one cavity and the at least one inwardly curved tab are located toward an outside of the hinge assembly and engage with one another when the hinge is in the open position.

27. The multipurpose hinge assembly of claim 18, wherein the at least one tab extends from an edge of the receptacle region.

28. A method of operating a hinge assembly comprising:
providing a first object including a male hinge portion and a mating surface having a ridge, wherein the male hinge portion includes a fulcrum that is connected to the mating surface;
providing a second object including a female hinge portion and a groove, wherein the female hinge portion includes a receptacle region located adjacent the groove;
engaging the fulcrum within the receptacle region; and
pivoting the second object about the first object until they abut thereby creating a substantially weatherproof seal by engaging the groove and the ridge.

29. The method of claim 28, further including creating a contiguous wall by abutting the ridge and the male hinge portion.

30. The method of claim 28, wherein the step of engaging the male and female hinge portions is accomplished by sapping the fulcrum into the receptacle region.

31. A method of limiting rotation of a hinge assembly comprising:
providing first object including a male hinge portion and at least one cavity disposed near the male portion,
providing a second object including a female hinge portion, wherein the female portion includes a receptacle region and at least one inwardly curved tab located near an edge of the receptacle region,
engaging the male hinge portion within the receptacle region of the female hinge portion; and
pivoting the second object relative to the first object in a direction such that the at least one tab engages with the at least one cavity, thereby preventing further rotation of the first object relative to the second object during the step of pivoting.

32. The method of claim 31, wherein the step of engaging of the first and second hinge portions is accomplished by sapping the fulcrum into the receptacle region.

33. A container comprising:
a body having a bottom, a side wall, an open top, and a mating surface having a ridge surrounding the open top;
a first hinge portion connected to the body near the mating surface, wherein the first hinge portion includes a fulcrum and a plurality cavities;
a lid having a perimeter including a groove and positionable to cover the top opening;
a second hinge portion connected to the lid, wherein the second hinge portion includes a receptacle region and a plurality of tabs, wherein the fulcrum is received in the receptacle region; and
wherein at least one tab and at least one cavity are located to the outside of the hinge assembly and engage with one another when the lid is in an open position, at least one tab and at least one cavity are located to the inside of the hinge assembly and engage with one another when the lid is in a closed position, and wherein the groove engages with the ridge when the lid is in the closed position.

34. The container of claim 33, wherein a combination of the first hinge portion and the ridge create a contiguous wall on the mating surface.

35. The container of claim 33, wherein a combination of the second hinge portion and the groove create a contiguous recess on the perimeter of the lid.

36. The container of claim 33, wherein the engagement of the first hinge portion and the ridge, with the second hinge portion and the groove create a substantially weatherproof seal when the lid is in the closed position.

37. The container of claim 33, wherein the plurality of tabs are part of the receptacle region.

38. The container of claim 33, wherein the fulcrum snaps into the receptacle region.

39. The container of claim 33, wherein the body and the lid are each constructed from one of a polyethylene, polypropylene, and polystyrene material.

40. The container of claim 33, wherein the first hinge portion and the body are integrally formed.

41. The container of claim 33, wherein the second hinge portion and the lid are integrally formed.

42. The container of claim 33, wherein the body and the lid are each manufactured using one of an injection molded, blow molded, continuously molded, extruded, and vacuum formed process.
